(19) United States
(12) Patent Application Publication
(10) Pub. No.: US 2026/0133795 A1
(43) Pub. Date: May 14, 2026

(54) IMPACT ANALYSIS APPARATUS, IMPACT ANALYSIS METHOD AND PROGRAM

(71) Applicant: NTT , Inc., Tokyo (JP)

(72) Inventors: Daisuke YAMAGUCHI, Tokyo (JP); Yuta KOIZUMI, Tokyo (JP); Tsutomu NOMOTO, Tokyo (JP)

(73) Assignee: NTT , Inc., Tokyo (JP)

(21) Appl. No.: 19/121,716

(22) PCT Filed: Oct. 19, 2022
(86) PCT No.: PCT/JP2022/038916

§ 371 Date: Apr. 16, 2025

(51) Int. Cl. G06F 8/71

(52) U.S. Cl. CPC G06F 8/71

(57) ABSTRACT

An impact analysis device acquires a list of method information related to a difference between a new version of a library and an old version of the library, based on a source code of the new version of the library and a source code of the old version of the library; extracts, from the list, a first difference related to a method existing in a first call graph of software that uses the old version of the library; extracts, from the list, a second difference related to a method added to a second call graph of the software that uses the new version of the library; extracts a set of method information of a caller of a transition added to the second call graph in comparison with the first call graph; and outputs a union of the first difference, the second difference, and the set, thereby enhancing support for determining a likelihood that a library update could affect operations of software.

### TECHNICAL FIELD

The present invention relates to an impact analysis device, an impact analysis method, and a program.

### BACKGROUND ART

In recent years, software has often been implemented using software libraries (hereinafter simply referred to as “library” or “libraries”). As libraries now have a fundamental role in software maintenance, keeping libraries updated becomes more important as a countermeasure for potential bugs, glitches, and security vulnerabilities in libraries.

However, libraries are not kept updated in the real world. Most software developers generally use outdated libraries. The main reason why libraries are not updated on time is that it is difficult to confirm that the software will run properly after updating the libraries. New versions of libraries are not necessarily compatible with older versions of libraries. Although methods have been proposed to indicate whether a new release is backward compatible (e.g. semantic versioning), there is no mandatory mechanism to match the displayed information to the actual status of backward compatibility, whereby backward compatibility cannot be guaranteed. Therefore, software developers need to verify whether the software is running properly every time of updating the libraries they use. Consequently, library updates are often postponed or cancelled.

To increase the number of library updates in this landscape, there is a demand for a scheme to enable easier determination on verifying whether software is running properly after updating a library.

Change impact analysis, also known as dependency impact analysis (hereinafter referred to as “impact analysis”) allows developers to assess the possible effect of a partial change in the software based on calling relationships (call graphs) between subroutines in a computer program. Impact analysis identifies the possible consequence of a change to anticipate any potential ripple effects such a change might have on different areas of the program to a certain extent. This empowers developers to fully visualize functions and modules that require impact assessments.

Since a library can also be considered as a component of the software, the impact analysis can help a developer focus only on those areas that are influenced by a change in the library, such as library updates. Eclipse Steady (NPL 1) is an example of impact analysis to identify the potential consequence of a change in a library program.

Eclipse Steady applies impact analysis to determine whether vulnerabilities discovered in a library program affect the entire software. Focusing on patches to fix library vulnerabilities and considering modifications in a library program made by the patches as a program causing the vulnerabilities, Eclipse Steady interprets call graphs up to the modifications and empowers developers to determine whether the software could potentially run the vulnerability-causing program. If there is no possibility that the software executes the vulnerability-causing program, it can be determined that the entire software is not affected by the vulnerabilities.

### CITATION LIST

### Non Patent Literature

[NPL 1] Serena Elisa Ponta, Henrik Plate, and Antonino Sabetta, “Detection, assessment and mitigation of vulnerabilities in open source dependencies,” Empirical Software Engineering, 25 (5): 3175-3215, 2020.

### SUMMARY OF INVENTION

### Technical Problem

Among the typical modifications made during library updates, there are some that make it difficult to determine the effect on software operation by analyzing the call graphs of the modifications in the library program.

Specifically, a program change called pull-up method (push-down method) is often performed by library updates. This change modifies a program called at runtime without rewriting the method's call site (a calling program). In other words, it suggests the need to consider that changes to the program that are found to be unexecutable from the software entry point by call graphs analysis may actually have effects on the behavior of the entire software. Eclipse Steady assumes that program modifications are caused by fixing vulnerabilities, so it does not support such program changes.

The present invention has been made to address the problems stated above, and an object of the present invention is to enhance support for determining a likelihood that a library update could affect operations of software.

### Solution to Problem

In order to solve the problems above, an impact analysis device includes an acquisition unit configured to acquire a list of method information related to a difference between a new version of a library and an old version of the library, based on a source code of the new version of the library and a source code of the old version of the library; a first extraction unit configured to extract, from the list, a first difference related to a method existing in a first call graph of software that uses the old version of the library; a second extraction unit configured to extract, from the list, a second difference related to a method added to a second call graph of the software that uses the new version of the library; a third extraction unit configured to extract a set of method information of a caller of a transition added to the second call graph in comparison with the first call graph; and an output unit configured to output a union of the first difference, the second difference, and the set.

### Advantageous Effects of Invention

According to the present invention, it is possible to enhance support for determining a likelihood that a library update could affect operations of software.

### BRIEF DESCRIPTION OF DRAWINGS

FIG. 1 is a view illustrating an example of the hardware configuration of an impact analysis device 10 according to an embodiment of the present invention.

FIG. 2 is a view illustrating a function configuration example of the impact analysis device 10 according to the embodiment of the present invention.

FIG. 3 is a flowchart illustrating an example of a processing procedure executed by the impact analysis device 10.

FIG. 4 is a flowchart illustrating an example of a processing procedure of call graph difference analysis.

### DESCRIPTION OF EMBODIMENTS

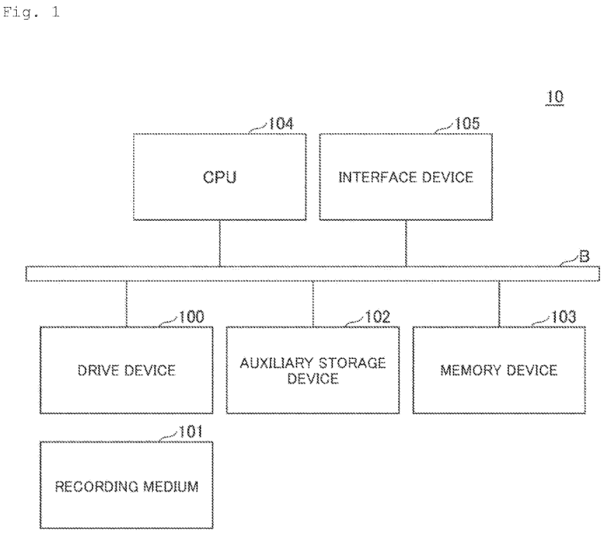

Hereinafter, embodiments of the present invention will be described with reference to the drawings. FIG. 1 is a view illustrating an example of the hardware configuration of an impact analysis device 10 according to an embodiment of the present invention. The impact analysis device 10 shown in FIG. 1 includes a drive device 100, an auxiliary storage device 102, a memory device 103, a CPU 104, and an interface device 105, which are connected with each other via a bus B.

A program which implements processing in the impact analysis device 10 is provided by a recording medium 101 such as a CD-ROM. When the recording medium 101 storing the program is set in the drive device 100, the program is installed from the recording medium 101 to the auxiliary storage device 102 via the drive device 100. However, the program does not necessarily have to be installed from the recording medium 101 and may be downloaded from another computer via a network. The auxiliary storage device 102 stores the installed program as well as necessary files and data.

The memory device 103 reads and stores the program from the auxiliary storage device 102 when an instruction for activating the program is issued. The CPU 104 executes functions related to the impact analysis device 10 according to the program stored in the memory device 103. The interface device 105 is used as an interface to connect to the network.

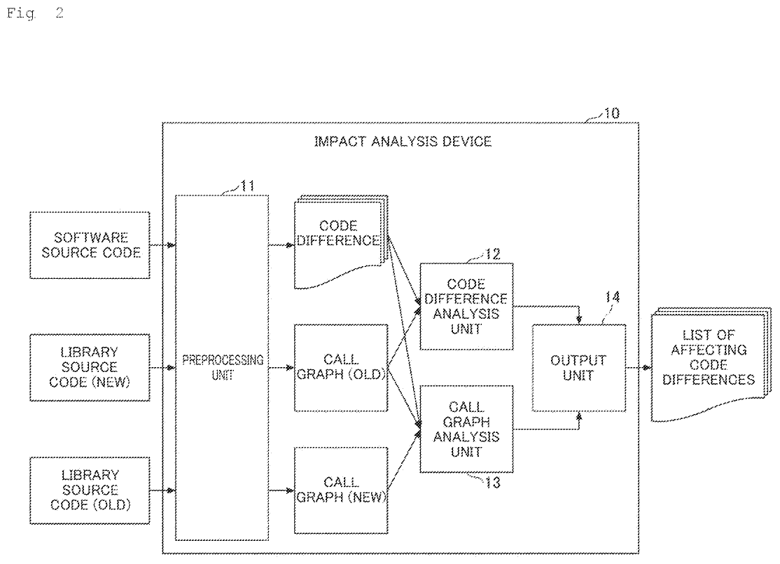

FIG. 2 is a view illustrating a function configuration example of the impact analysis device 10 according to the embodiment of the present invention. The impact analysis device 10 supports verification of whether software is running properly after a library update by performing impact analysis on a change in a library program caused by the library update. For executing reach determination by analyzing a call graph with a software entry point (a single point where the program is initially executed) as a start method, and impact analysis using call graph differences acquired from call graphs of the software before the library update and the software after the library update, the impact analysis device 10 includes a preprocessing unit 11, a code difference analysis unit 12, a call graph analysis unit 13, and an output unit 14 as shown in FIG. 2. These units are implemented by processing which at least one of programs installed in the impact analysis device 10 causes the CPU 104 to execute.

The preprocessing unit 11 inputs and executes preprocessing on a source code of the software (program) that uses the library, a source code of the updated (changed) library (hereinafter also referred to as “new version library”), and a source code of the not-yet updated (changed) library (hereinafter also referred to as “old version library”).

The code difference analysis unit 12 analyzes a likelihood that the library update could affect software operation based on a code difference before and after changing the library.

The call graph analysis unit 13 analyzes a likelihood that the library update could affect software operation based on call graphs before and after changing the library.

The output unit 14 outputs an analysis result that is a combination of the analysis results of the code difference analysis unit 12 and the call graph analysis unit 13 as an impact analysis result.

The impact analysis results are shown as a list of library code differences that could have impacts on the software. If the output list is empty, it is understood that no code modifications in the library are executable from the software, and thus it is guaranteed that the software will work properly even after the library update. On the other hand, if the output list is not empty, there is a likelihood that the software could not run properly after the library update due to the program that includes the code differences included in the list.

Next, a data structure used in the present embodiment will be defined.

### [Source Code]

The source code has the following abstract syntax.

$$\begin{matrix}CLASS C & := & class C extend D \{ cns \overline{m} \} \\ CONSTRUCTOR cns & := & C ( \overline{C x} ) \{ \overline{t} ; \} \\ METHOD m & := & τ m ( \overline{C x} ) \{ \overline{t} ; \}\end{matrix} \qquad [ Math . 1 ]$$

$$z represents zero or more repetitions of the Expression z .$$

Class C includes a declaration of a class name C and a declaration of a subclass (parent class) D. The definition of a class body consists of the definitions of a constructor cns and a method m. τ is a meta-symbol representing a type, x is a meta-symbol representing a variable, and t is a meta-symbol representing a sentence.

### [Code Difference]

The code difference is a set of a class name and an API name (method name) (information equivalent to a complete qualifier of the API (method)). The entire source code differences caused by library updates are treated as a code difference list Δ below.

$$\begin{matrix}CODE DIFFERENCE LIST Δ & := & δ Δ \\ CODE DIFFERENCE δ & := & ( C , name ) \\ API NAME name & := & m \vert cons\end{matrix} \qquad [ Math . 2 ]$$

### [Call Graph]

A call graph of one program is defined by a single triplet (S, s₀, R). S is a set of methods or constructors (hereinafter collectively referred to as “methods”) in the program, and so is an entry point of the program. R is a transitive relation between the methods, and R⊆S×S. That is, R is a subset of the Cartesian product set (S×S) between the methods that also include entry points.

If an element s of S can be reached by the transitive relation R from the entry point, s becomes an element of a set of methods called directly or indirectly from the software. For example, if a call graph of the software is defined by:

S={a,b,c,d}
s₀={a}
R={r(a->b),r(b->d)} (x->y means “x calls y”),

among the elements of S, a set of methods called directly or indirectly by software is an element {a, b, d} that can be reached by tracing the transitive relation R from a.

A “relationship” in the transitive relation means a relation in mathematics (especially a binary relation). Therefore, the transitive relation R is data that expresses all “calling relationships” between the methods (that is, pairs related by R) using a single piece of data such as a tree structure.

Since s∈S is a method of the program, a class name and a method name (or a constructor name in the case of a constructor) on the program are uniquely defined for s. In the present embodiment, getQName(s), which is a function to obtain the method name (method information) corresponding to s, is defined as follows.

### Definition 1 (getQName)

S is a set of methods in a call graph, and it satisfies s∈S. At this time,

getQName(s)=(Cₛ,nₛ). <==>Cₙ is the class name of s, and nₛ is the method name of s.

Further, the following is defined.

### Definition 2 (One-Step Transition)

When sₐ, s_{b}∈S and r∈R, r=(sₐ,s_{b}) is written as s_{b}=r(sₐ) or sₐ=r⁻¹(s_{b}). Note that in r=(a,b), a is a caller and b is a callee.

### LIST OF AFFECTING CODE DIFFERENCES

An affecting code difference list is a list (that is, a sublist) that forms a part of the source code difference list.

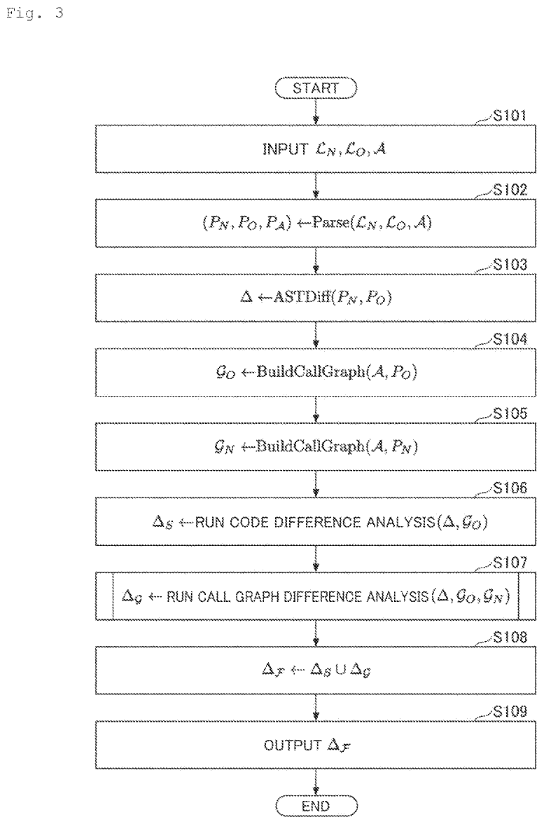

Hereinbelow, a description will be given of a processing procedure executed by the impact analysis device 10. FIG. 3 is a flowchart illustrating an example of a processing procedure executed by the impact analysis device 10.

In step S101, the preprocessing unit 11 inputs a new version library source code L_{N}, an old version library source code L_{O}, and a software source code A. A is software that uses a library.

Next, the preprocessing unit 11 parses each input source code (L_{N}, L_{O}, A) and generates each abstract syntax tree (AST) (S102). The AST of L_{N} is assigned to P_{N}, the AST of L_{O} is assigned to P_{O}, and the AST of A is assigned to P_{A}.

Next, the preprocessing unit 11 generates a list 4 of differences between the ASTs of P_{N} and P_{O} (a list of code differences between the new version and the old version of the library) (S103). Known techniques can be used to obtain the AST difference. For example, the difference may be obtained using a tool such as gumtree diff.

Next, the preprocessing unit 11 generates a call graph G_{O} of the new version of the software (A calls L_{O}) (S104).

Next, the preprocessing unit 11 generates a call graph G_{N} of the old version of the software (A calls L_{N}) (S105).

Note that known techniques can be used to generate the call graphs in steps S104 and S105. For example, the call graphs may be generated using a tool such as WALA or Soot.

Next, the code difference analysis unit 12 performs code difference analysis on the list Δ of code differences (differences in method information) between the new version and the old version of the library based on the call graph G_{O}, and outputs an analysis result Δ_{S} (S106). Code difference analysis refers to filtering a code difference list so as to leave methods that exist on the call graph (in other words, it is to extract code differences related to methods existing on the call graph (here, call graph G_{O}) from the code difference list).

Specifically, when the call graph is G=(S_{G},s_{GO},R_{G}), the code difference analysis result is given by the following expression Δ_{S}.

$${Δ}_{S} = \{ ( C , name ) ∈ Δ \vert s ∈ {S}_{𝒢} ⋀ ( C , name ) = getQName ( s ) \} \qquad [ Math . 3 ]$$

provided that the definition of getQName follows Definition 1.

Next, the call graph analysis unit 13 executes call graph difference analysis based on the call graph G_{O} and the call graph G_{N} of the code difference list Δ, and outputs an analysis result Δ_{G} (S107).

Next, the output unit 14 finds the union of Δ_{S} and Δ_{G} (Δ_{S}∪Δ_{G}), and assigns the union to Δ_{F} (S108).

Next, the output unit 14 outputs Δ_{F} (S109).

If Δ_{F} is an empty set, the user determines that there is no likelihood that the library update could affect the overall software operation, and if otherwise, determines that there is a likelihood that the operation could be affected.

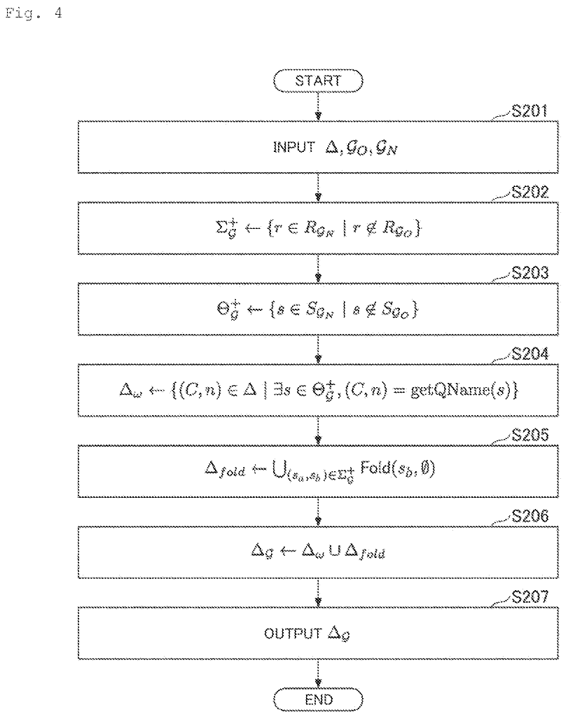

Next, step S107 will be described in detail. FIG. 4 is a flowchart illustrating an example of a processing procedure of call graph difference analysis.

In step S201, the call graph analysis unit 13 inputs the code difference list Δ, the call graph G_{O}, the call graph G_{N}. G_{N} is the call graph of the (new version) software after the library update, and G_{N}=(S_{GN},s_{NO},R_{GN}). Furthermore, G_{O} is the call graph of the (old version) software before the library update, and G_{O}=(S_{GO},s_{O0},R_{GO}).

Next, the call graph analysis unit 13 extracts a transition added to G_{N} in comparison with G_{O}, and assigns the extraction result to Σ⁺_{G} (S202). The transition added to G_{N} for G_{O} is a transition that is included in G_{N} but not included in G_{O}.

Next, the call graph analysis unit 13 extracts a method added to G_{N} in comparison with G_{O}, and assigns the extraction result to Φ⁺_{G} (S203).

Next, the call graph analysis unit 13 extracts a code difference Δ_{ω} related to the method included in Φ⁺_{G} from the code difference list Δ (S204).

Next, the call graph analysis unit 13 adds up a result of applying Fold to each element r=(sₐ,s_{b}) of the transition Σ⁺_{G} added to G_{N} (finds the union of each result), and calculates Δ_{fold} (S205). Note that r is a transition from sₐ to s_{b}. The definition of Fold will be explained hereinbelow.

In the present embodiment, when a new method is added to the call graph, this modification is regarded as being caused by a change in the call site (calling program, i.e. software that uses a library, or alternatively, calling method in a calling relationship between libraries). In the pull-up method and push-down method, no change is seen in the call site, but since a method called during execution is modified, it is assumed that there is a change in the call site.

When a new transition (calling relationship between the methods) is added to the call graph (in the present embodiment, the new transition is found between G_{O} and G_{N}), Fold discovers and returns the method or constructor of the call site that has caused the addition. Generally, there are multiple call sites, so Fold returns calculation results as a set. Fold is a function that receives a method or a constructor on the call graph, and a memo set (φ (empty set) in S205 in FIG. 4), and returns a set whose elements are methods. Fold is defined recursively as follows, and processing proceeds by tracing the call graph. Since the transitive relation R of the call graph allows circulation, there is a likelihood that Fold would continue tracing the call graph without stopping. Therefore, the call graph analysis unit 13 records the methods that have been traced once in a memo and detects that a method that has been traced once is revisited, thereby preventing Fold from continuing to trace the call graph and not stopping.

$$Fold ( s , M ) = \{ \begin{matrix}∅ & ( if s ∈ M ) \\ \{ getQName ( s ) \} & ( if s ∈ {S}_{{𝒢}_{O}} ) \\ {⋃}_{{s}^{′} ∈ \{ {r}^{- 1} ( s ) \vert r ∈ {R}_{{𝒢}_{N}} \}} Fold ( {s}^{′} , M ⋃ \{ s \} ) & ( otherwise )\end{matrix}$$

That is, for Fold(s,M), if s is an element of M, Fold(s,M) returns φ (empty set). If s is an element in a call graph S_{GO} of the old version, Fold(s,M) returns method information (C, name) of s. Otherwise, Fold(s,M) returns the union of return values of Fold(s′,M∪{s}) for each s′ that calls s in the call graph R_{GN} of the new version. At this time, s is added to M as checked.

Next, the call graph analysis unit 13 assigns the union of Δ_{ω} and Δ_{fold} to Δ_{G} (S206).

Next, the call graph analysis unit 13 outputs Δ_{G} as an analysis result (S207).

As mentioned above, according to the present embodiment, it is possible to determine the likelihood that a library update could affect the overall software operation, including the likelihood that a program change called a pull-up method (push-down method) could affect the operation. In other words, according to the present embodiment, it is possible to enhance support for determining a likelihood that a library update could affect operations of software.

In the present embodiment, the preprocessing unit 11 is one example of the acquisition unit. The code difference analysis unit 12 is one example of the first extraction unit. The call graph analysis unit 13 is one example of the second extraction unit and the third extraction unit. Δ_{S} is one example of the first difference. Δ_{ω} is one example of the second difference. Δ_{fold} is one example of the third difference. G_{O} is one example of the first call graph. G_{N} is one example of the second call graph.

Although the embodiments of the present invention have been described in detail above, the present invention is not limited to these particular embodiments, and various modifications and improvements are encompassed in the scope of the accompanying claims without departing the gist of the present invention.

### REFERENCE SIGNS LIST

10 Impact analysis device
11 Preprocessing unit
12 Code difference analysis unit
13 Call graph analysis unit
14 Output unit
100 Drive device
101 Recording medium
102 Auxiliary storage device
103 Memory device
104 CPU
105 Interface device
B Bus

1. An impact analysis device comprising:
acquiring a list of method information related to a difference between a new version of a library and an old version of the library, based on a source code of the new version of the library and a source code of the old version of the library;
extracting, from the list, a first difference related to a method existing in a first call graph of software that uses the old version of the library;
extracting, from the list, a second difference related to a method added to a second call graph of the software that uses the new version of the library;
extracting a set of method information of a caller of a transition added to the second call graph in comparison with the first call graph; and
output a union of the first difference, the second difference, and the set.

2. The impact analysis device according to claim 1, wherein the difference between the new version of the library and the old version of the library is a difference between an abstract syntax tree of the new version of the library and an abstract syntax tree of the old version of the library.

3. The impact analysis device according to claim 1, wherein the method information is information including a class name and a method name of the method.

4. An impact analysis method causing a computer to execute, the method comprising:
acquiring a list of method information related to a difference between a new version of a library and an old version of the library, based on a source code of the new version of the library and a source code of the old version of the library;
extracting, from the list, a first difference related to a method existing in a first call graph of software that uses the old version of the library;
extracting, from the list, a second difference related to a method added to a second call graph of the software that uses the new version of the library;
extracting a set of method information of a caller of a transition added to the second call graph in comparison with the first call graph; and
outputting a union of the first difference, the second difference, and the set.

5. A computer-readable non-transitory recording medium storing computer-executable program instructions that when executed by a processor cause a computer to execute an impact analysis method comprising:
acquiring a list of method information related to a difference between a new version of a library and an old version of the library, based on a source code of the new version of the library and a source code of the old version of the library;
extracting, from the list, a first difference related to a method existing in a first call graph of software that uses the old version of the library;
extracting, from the list, a second difference related to a method added to a second call graph of the software that uses the new version of the library;
extracting a set of method information of a caller of a transition added to the second call graph in comparison with the first call graph; and
outputting a union of the first difference, the second difference, and the set.

6. The impact analysis method according to claim 4, wherein the difference between the new version of the library and the old version of the library is a difference between an abstract syntax tree of the new version of the library and an abstract syntax tree of the old version of the library.

7. The impact analysis method according to claim 4, wherein the method information is information including a class name and a method name of the method.

8. The computer-readable non-transitory recording medium according to claim 5 wherein the impact analysis method further comprises:
the difference between the new version of the library and the old version of the library is a difference between an abstract syntax tree of the new version of the library and an abstract syntax tree of the old version of the library.

9. The computer-readable non-transitory recording medium according to claim 5 wherein the impact analysis method further comprises, wherein the method information is information including a class name and a method name of the method.

10. The impact analysis device according to claim 2, wherein a first call graph is generated based on the old version of the library and a second call graph is generated based on the new version of the library and extract a set of method information of a caller of a transition added to the second call graph by comparing the second call graph with the first call graph.
